(19) United States
(12) Patent Application Publication
(10) Pub. No.: US 2013/0089651 A1
(43) Pub. Date: Apr. 11, 2013

(54) REDUCED ALUMINUM CHEMICAL LEAVENING COMPOSITIONS

(71) Applicant: INNOPHOS, INC., Cranbury, NJ (US)

(72) Inventors: Robert Finn, Westfield, NJ (US); Diana Jaramillo, Edison, NJ (US); Yu Liu, Yardley, PA (US)

(73) Assignee: INNOPHOS, INC., Cranbury, NJ (US)

(21) Appl. No.: 13/646,701

(22) Filed: Oct. 6, 2012

Related U.S. Application Data
(60) Provisional application No. 61/545,037, filed on Oct. 7, 2011.

(51) Int. Cl. A21D 2/02

(52) U.S. Cl. CPC A21D 2/02
USPC 426/563

(57) ABSTRACT

The present invention relates to a chemical leavening composition for the production of bakery products with a carbon dioxide source and an acid component wherein the acid component comprises SAPP and a magnesium phosphate compound and mixtures thereof.

### BACKGROUND OF THE INVENTION

(1) Field of the Invention

The present invention relates to a reduced aluminum chemical leavening composition. Presently, there is a perceived need in the food industry to reduce the levels of aluminum in food products. For example, in the baking industry, the leavening acid, sodium acid pyrophosphate (SAPP) utilizes several additives at low levels to control the leavening reaction with sodium bicarbonate within dough formulations. The SAPP leavening acid minimizes the release of CO2 during mixing so the majority of the CO2 is left for leavening during the baking process. A traditional low level additive is based on an aluminum compound, but regulations in some jurisdictions (such as Europe) have been proposed to reduce aluminum limits to very low levels.

(2) Description of the Related Art

US 2011/0111110 assigned to Chemische Fabrik Budenheim discloses a leavening composition containing acid magnesium pyrophosphate and a magnesium orthophosphate produced by removal of water from an aqueous solution of a magnesium phosphate compound. Said magnesium phosphate compound is preferably mono magnesium orthophosphate. Example 1 describes the following process for producing acid magnesium pyrophosphate: magnesium sources such as a Mg (OH)2, MgO, or MgCO3 are stirred into phosphoric acid to produce a magnesium phosphate solution. The magnesium phosphate solution is then converted into an acid magnesium pyrophosphate with a drying assembly at a temperature of 140 C to 300C.

Now, Applicants have met the industry need for a reduced aluminum leavening system.

### BRIEF SUMMARY OF THE INVENTION

The present invention relates to a chemical leavening composition for the production of bakery products with a carbon dioxide source and an acid component wherein the acid component comprises SAPP and a magnesium phosphate compound and mixtures thereof.

The present invention further relates to a chemical leavening composition for the production of bakery products with a carbon dioxide source and an acid component wherein the acid component comprises SAPP and a magnesium phosphate compound wherein further said magnesium phosphate is created in situ during the SAPP formation reaction by incorporating a reactant selected from the group consisting of MgO, Mg(OH)₂,and Mg3(PO4)2.8H2O(trimagnesium phosphate) and mixtures thereof.

The following terms have the following meaning herein:

MgO is magnesium oxide

Mg(OH)2 is magnesium hydroxide

Mg3(PO4)2.8H2O is trimagnesium phosphate.

### DETAILED DESCRIPTION OF THE INVENTION

The present invention relates to a chemical leavening composition for the production of bakery products with a carbon dioxide source and an acid component wherein the acid component comprises SAPP and a magnesium phosphate compound and mixtures thereof.

The present invention further relates to a chemical leavening composition for the production of bakery products with a carbon dioxide source and an acid component wherein the acid component comprises SAPP and a magnesium phosphate compound wherein further said magnesium phosphate is created in situ during the SAPP formation reaction by incorporating a reactant selected from the group consisting of Mg O, Mg(OH)₂,and Mg3(PO4)2.8H20 (trimagnesium phosphate) and mixtures thereof.

Reactants useful in the practice of the present invention include, but are not limited to, Mg O, Mg(OH)₂,and Mg3(PO4)2.8H2O (trimagnesium phosphate) and mixtures thereof.

The following non limiting examples illustrate the practice of the present invention and its utility.

### Example 1

### Baking-Powder grade SAPP recipe for total of 250 g final product

| Dopants | Percent (%) | Grams |
|---|---|---|
| Tricalcium Phosphate | 0.1 | 0.25 |
| Dicalcium Phosphate | 0.3 | 0.75 |
| Dihydrate | | |
| Al(OH)₃ | 0.1 | 0.25 |
| Substitute MgO | 0.36% | |
| Dipotassium Phosphate | 0.18 | 0.45 |
| Na₂CO₃ | (extra 1.2% of soda ash in | 120 |
| | order to increase pH of 1% | |
| | solution on final product to be | |
| | in the range of 4.0-4.3) | |
| 85% H₃PO₄ | | 257.9 |

### Procedure

Using dispersator, add dopants to acid and mix for 5 min
Add soda ash through the vibrating feeder. Control speed according to production of CO₂ to provide a homogeneous mixing
Total time of addition of soda ash between 25-30 min
Continue mixing for 5 min and stop dispersator
Discharge sample into crucible and place in oven set up at 220° C. for 2.5 hours
Mill sample using shatterbox for 2 min

### Example 2

### SAPP 4 recipe for total of 250 g final product

| Dopants | Percent (%) | Grams |
|---|---|---|
| Calcium Oxide | 0.3 | 0.75 |
| Tricalcium Phosphate | 0.1 | 0.25 |
| Dicalcium Phosphate | 1.7 | 4.25 |
| Dihydrate | | |
| Al₂(OH)₃ | 0.3 | 0.75 |
| Substitute MgO | 1.08% | |
| Dipotassium Phosphate | 0.76 | 1.9 |
| Na₂CO₃ | | 115.6 |
| 85% H₃PO₄ | | 251.5 |

### Procedure

Follow same procedure as BP Pyro
After milling, place sample back in the oven for the reforming step
Reforming conditions: 250° C. for 1 hour

We claim:

1. A chemical leavening composition for the production of bakery products with a carbon dioxide source and an acid component wherein the acid component comprises SAPP and a magnesium phosphate compound and mixtures thereof.

2. A chemical leavening composition for the production of bakery products with a carbon dioxide source and an acid component wherein the acid component comprises SAPP and a magnesium phosphate compound wherein further said magnesium phosphate is created in situ during the SAPP formation reaction by incorporating a reactant selected from the group consisting of Mg O, Mg(OH)₂,and Mg3(PO4)2.8H2O and mixtures thereof.
